(19) United States
(12) Patent Application Publication
(10) Pub. No.: US 2021/0060992 A1
(43) Pub. Date: Mar. 4, 2021

(54) ENVIRONMENTALLY FRIENDLY WATER TRANSFER PRINTING METHOD AND CORRESPONDING SURFACE STRUCTURE OF A COMPONENT

(71) Applicant: KUNSHAN REN QUAN LASER TECHNOLOGY CO., LTD, Suzhou (CN)

(72) Inventor: Shiquan Cai, Suzhou (CN)

(73) Assignee: KUNSHAN REN QUAN LASER TECHNOLOGY CO., LTD, Suzhou (CN)

(21) Appl. No.: 16/956,811

(22) PCT Filed: Dec. 26, 2017
(86) PCT No.: PCT/CN2017/118565

§ 371 Date: Jun. 22, 2020

(30) Foreign Application Priority Data
Dec. 25, 2017 (CN) 201711416645.3

(51) Int. Cl. B41M 5/00; B41M 5/04; C09D 11/102; C09D 175/04

(52) U.S. Cl. CPC B41M 5/0011; C09D 175/04; C09D 11/102; B41M 5/04

(57) ABSTRACT

An environmentally friendly water transfer printing method is provided that includes applying water-based primer to a surface of a subject; using a water transfer printing membrane including a modified water-based ink multi-color printing pattern, so that a water-soluble film of the water transfer printing membrane absorbs water and dissolves to swell the modified water-based ink, and the water-based primer is combined with the modified water-based ink to make the surface of the object attach a pattern. The environmentally friendly water transfer printing method and a corresponding surface structure of a component uses modified water-based ink in the water transfer printing membrane during the water transfer printing. No activator, which is a mixed solvent of multiple solvents or multiple mixed solvents, is used during the method, so there is no VOC discharge.

### FIELD OF THE INVENTION

The present invention relates to a water transfer printing technology, and specifically relates to an environmentally friendly water transfer printing method and corresponding surface structure of a component.

### BACKGROUND

In order to increase the aesthetics of an object or other actual needs, the surface of the object needs to be decorated. At present, water transfer printing technology is usually used to decorate the surface of objects with complex and changeable three-dimensional structures or curved objects. In the process of water transfer printing, a large amount of VOC will be generated due to the use of activator, which pollutes the environment and does not comply with the relevant environmental protection regulations. Therefore, it is necessary to provide a simple and effective water transfer printing process to solve the problems of the prior art water transfer printing process that a large amount of VOC discharge and are not environmentally friendly.

### SUMMARY OF THE INVENTION

The purpose of the present invention is to overcome the above-mentioned shortcomings of the prior art, and to provide a simple and effective environmentally friendly water transfer printing method and corresponding surface structure of a component with no VOC discharge.

In order to achieve the above purpose, the environmentally friendly water transfer printing method of the present invention is as follows: comprising:

Applying water-based primer to a surface of a subject;
Using a water transfer printing membrane comprising a modified water-based ink multi-color printing pattern, so that a water-soluble film of the water transfer printing membrane absorbs water and dissolves to swell the modified water-based ink, and the water-based primer is combined with the modified water-based ink to make the surface of the object attach a pattern.

Preferably the modified water-based ink is modified polyurethane comprising hydroxyl, sulfonate and isocyanate groups, and the water-based primer is modified polyurethane comprising hydroxyl and isocyanate groups.

The present invention provides an environmentally friendly water transfer printing method, comprising:

Applying water-based primer to a surface of an object;
Placing a water transfer printing membrane with a multi-color water-based ink printing pattern on a water surface, so that a water-soluble film of the water transfer printing membrane absorbs water and dissolves to swell the modified water-based ink; and
Performing the water transfer printing on the object, and the water-based primer on the surface of the object is combined with the water transfer printing membrane with a multi-color water-based ink printing pattern to make the surface of the object attach a pattern.

Preferably the modified water-based ink is modified polyurethane comprising hydroxyl, sulfonate and isocyanate groups, and the water-based primer is modified polyurethane comprising hydroxyl and isocyanate groups.

Preferably the water transfer printing membrane with a multi-color water-based ink printing pattern comprising:

A water-soluble film;
A multi-color water-based ink printing pattern formed on the water-soluble film; and
A metal nanoparticle layer formed on the multi-color water-based ink printing pattern.

Preferably the method further comprising: cleaning the surface of the object to which the pattern is attached, then blowing and baking the surface of the object.

Preferably the method further comprising: spraying protective paint and/or topcoat on the surface of the object after baking.

The present invention provides an environmentally friendly water transfer printing method, comprising steps:

(1): Pre-treatment of a surface of an object;
(2): Applying water-based primer to the surface of the object;
(3): Placing a water transfer printing membrane with a multi-color water-based ink printing pattern on a water surface, and performing the water transfer printing on the object to make the surface of the object attach a pattern.

Preferably a water temperature during the water transfer printing in the step (3) is 25° C. to 30° C.

Preferably the method further comprising steps:

(4): soaking the surface of the object with hot water for 5 minutes, in which the water temperature is between 45° C. and 50° C.;
(5): Cleaning with water under pressure and blow off the surface water stains;
(6): Drying the object above 50° C. until the water completely evaporates;
(7): Spraying protective paint and/or topcoat.

The present application provides a surface structure of a component, comprising a primer layer, a multi-color water-based ink printing pattern layer, and a metal nanoparticle layer which are sequentially arranged on a surface of the component.

Preferably the structure further comprising a protective paint layer provided on an outer surface of the metal nanoparticle layer.

Preferably the primer layer is a water-based primer layer.

Preferably the surface of the component has a regular geometric profile or an irregular stereoscopic curved surface.

The present invention provides a surface structure of a component, wherein a surface of the component is processed by the environmentally friendly water transfer printing method to form the surface structure of the component, and the surface structure of the component is attached with a pattern.

The environmentally friendly water transfer printing method and a corresponding surface structure of a component according to the present invention, wherein modified water-based ink is used in the water transfer printing membrane during the water transfer printing, so that the water-soluble film absorbs water and the modified water-based ink swells to a transferable state, then the water transfer printing membrane can be combined with the primer on the surface of the subject to make the attachment stronger. No activator, which is a mixed solvent of multiple solvents or multiple mixed solvents, is used during the method, so there is no VOC discharge.

### DETAILED DESCRIPTION

In order to be able to understand the technical content of the present invention more clearly, the following embodiments are specifically described.

The environmentally friendly water transfer printing method of the present invention comprising:

Applying water-based primer to a surface of a subject;
Using a water transfer printing membrane comprising a modified water-based ink multi-color printing pattern, so that a water-soluble film of the water transfer printing membrane absorbs water and dissolves to swell the modified water-based ink, and the water-based primer is combined with the modified water-based ink to make the surface of the object attach a pattern.

In a preferred embodiment, the modified water-based ink is modified polyurethane comprising hydroxyl, sulfonate and isocyanate groups, and the water-based primer is modified polyurethane comprising hydroxyl and isocyanate groups.

Modified water-based ink can be selected from acrylic ester modified waterborne polyurethane emulsion. Hydroxyl and sulfonate groups are used as the hydrophilic group of water-based polyurethane emulsion. The sulfonate group —SO₃R in the chemical structure is extremely water-soluble, so it will dissolve instantly when encountering water during water transfer printing, and it can be biodegraded, which is environmentally friendly. Control the amount of sulfonate group —SO₃R in the modified water-based ink until the water-based ink swells with water and dissolves slightly.

When the modified water-based ink meets water, due to the presence of good water-soluble sodium sulfonate in the chemical structure, the water-based ink swells in a short time; after water transfer printing, the water-based ink is combined with the water-based primer by physical adsorption and chemical bonding. In the above acrylic ester-modified water-based polyurethane emulsion, hydroxyethyl methacrylate can be selected for modification to make the entire product structure contain hydroxyl groups.

Physical adsorption: The attachment of the water-based primer to the substrate is generated by the van der Waals force between the —OH in the emulsion structure and the substrate. The combination of the water-based ink film and the water-based primer achieves the bonding effect through physical adsorption. The bonding effect depends on the wettability. By wetting, the water-based ink and the substrate are in close contact, and the bonding interface will form a huge intermolecular force. Affected by the hydroxyl groups in the water-based ink, the higher the hydroxyl groups content, the closer the contact with the primer, the stronger the intermolecular force formed, and the better the bonding effect.

Chemical bond theory: chemical bonds include ionic bonds, covalent bonds and metal bonds. Acrylate modified water-based polyurethane adhesives in water-based ink and water-based polyurethane adhesive water-based primers are highly prone to chemical reactions between molecules to produce high-strength chemical bonds, mainly ionic bonds and covalent bonds. The water-based ink contains hydroxyl groups, which easily react with —NCO in water-based primer: R—OH+R′—NCO→ROCONHR′

In addition, each of the primer, topcoat, and water-based ink multi-color printing pattern layer may comprise isocyanate groups R′—NCO, hydroxyl, and other groups.

The present invention provides an environmentally friendly water transfer printing method, comprising:

Applying water-based primer to a surface of an object;
Placing a water transfer printing membrane with a multi-color water-based ink printing pattern on a water surface, so that a water-soluble film of the water transfer printing membrane absorbs water and dissolves to swell the modified water-based ink; and
Performing the water transfer printing on the object, and the water-based primer on the surface of the object is combined with the water transfer printing membrane with a multi-color water-based ink printing pattern to make the surface of the object attach a pattern.

In a preferred embodiment, the modified water-based ink is modified polyurethane comprising hydroxyl, sulfonate and isocyanate groups, and the water-based primer is modified polyurethane comprising hydroxyl and isocyanate groups.

In a preferred embodiment, the water transfer printing membrane comprising:

A water-soluble film;
A multi-color water-based ink printing pattern formed on the water-soluble film; and
A metal nanoparticle layer formed on the multi-color water-based ink printing pattern.

In a preferred embodiment, the method further comprising: cleaning the surface of the object to which the pattern is attached, then blowing and baking the surface of the object.

In a preferred embodiment, the method further comprising: spraying protective paint and/or topcoat on the surface of the object after baking.

The present invention provides an environmentally friendly water transfer printing method, comprising steps:

(1): Pre-treatment of a surface of an object;
(2): Applying water-based primer to the surface of the object;
(3): Placing a water transfer printing membrane with a multi-color water-based ink printing pattern on a water surface, and performing the water transfer printing on the object to make the surface of the object attach a pattern.

In a preferred embodiment, a water temperature during the water transfer printing in the step (3) is 25° C. to 30° C.

In a preferred embodiment, the method further comprising steps:

(4): soaking the surface of the object with hot water for 5 minutes, in which the water temperature is between 45° C. and 50° C.;
(5): Cleaning with water under pressure and blow off the surface water stains;
(6): Drying the object above 50° C. until the water completely evaporates;
(7): Spraying protective paint and/or topcoat.

The present application provides a surface structure of a component, comprising a primer layer, a multi-color water-based ink printing pattern layer, and a metal nanoparticle layer which are sequentially arranged on a surface of the component.

In a preferred embodiment, the structure further comprising a protective paint layer provided on an outer surface of the metal nanoparticle layer.

In a preferred embodiment, the primer layer is a water-based primer layer.

In a preferred embodiment, the surface of the component has a regular geometric profile or an irregular stereoscopic curved surface.

The present invention provides a surface structure of a component, wherein a surface of the component is processed by the environmentally friendly water transfer printing method to form the surface structure of the component, and the surface structure of the component is attached with a pattern.

According to the environmentally friendly water transfer printing method of the present invention, no activator (a mixed solvent of multiple solvents, or multiple mixed solvents) is used, the VOC discharge is 0, and it can be directly coated on the surface of the subject to quickly form a pattern on the surface of the subject; even if the surface of the subject is uneven, a pattern with a uniform thickness can be formed.

The environmentally friendly water transfer printing method and a corresponding surface structure of a component according to the present invention, wherein modified water-based ink is used in the water transfer printing membrane during the water transfer printing, so that the water-soluble film absorbs water and the modified water-based ink swells to a transferable state, then the water transfer printing membrane can be combined with the primer on the surface of the subject to make the attachment stronger. No activator, which is a mixed solvent of multiple solvents or multiple mixed solvents, is used during the method, so there is no VOC discharge.

In this specification, the present utility model has been described with reference to its specific embodiments. However, it is clear that various modifications and changes can still be made without departing from the spirit and scope of the present utility model. Therefore, the description and drawings should be regarded as illustrative rather than restrictive.

1. An environmentally friendly water transfer printing method, comprising:
applying water-based primer to a surface of a subject;
using a water transfer printing membrane comprising a modified water-based ink multi-color printing pattern, so that a water-soluble film of the water transfer printing membrane absorbs water and dissolves to swell the modified water-based ink, and the water-based primer is combined with the modified water-based ink to make the surface of the object attach a pattern.

2. The environmentally friendly water transfer printing method according to claim 1, wherein the modified water-based ink is modified polyurethane comprising hydroxyl, sulfonate and isocyanate groups, and the water-based primer is modified polyurethane comprising hydroxyl and isocyanate groups.

3. An environmentally friendly water transfer printing method, comprising:
applying water-based primer to a surface of an object;
placing a water transfer printing membrane with multi-color water-based ink printing pattern on a water surface, so that a water-soluble film of the water transfer printing membrane absorbs water and dissolves to swell the modified water-based ink; and
the water transfer printing on the object, and the water-based primer on the surface of the object is combined with the modified water-based ink to make the surface of the object attach a pattern.

4. The environmentally friendly water transfer printing method according to claim 3, wherein the modified water-based ink is modified polyurethane comprising hydroxyl, sulfonate and isocyanate groups, and the water-based primer is modified polyurethane comprising hydroxyl and isocyanate groups.

5. The environmentally friendly water transfer printing method according to claim 3, wherein the water transfer printing membrane comprising:
a water-soluble film;
a multi-color water-based ink printing pattern formed on the water-soluble film; and
a metal nanoparticle layer formed on the multi-color water-based ink printing pattern.

6. The environmentally friendly water transfer printing method according to claim 3, wherein the method further comprises cleaning the surface of the object to which the pattern is attached, then blowing and baking the surface of the object.

7. The environmentally friendly water transfer printing method according to claim 6, wherein the method further comprises spraying protective paint, a topcoat, or both the protective paint and the topcoat on the surface of the object after baking.

8. An environmentally friendly water transfer printing method, comprising:
pre-treating of a surface of an object;
applying water-based primer to the surface of the object;
placing a water transfer printing membrane with multi-color water-based ink printing pattern on a water surface, and performing the water transfer printing on the object to make the surface of the object attach with a pattern.

9. The environmentally friendly water transfer printing method according to claim 8, wherein a water temperature during the water transfer printing in the placing step is 25° C. to 30° C.

10. The environmentally friendly water transfer printing method according to claim 9, wherein the method further comprising:
soaking the surface of the object with hot water for 5 minutes, in which the water temperature is between 45° C. and 50° C.;
cleaning with water under pressure and blow off the surface water stains;
drying the object above 50° C. until the water completely evaporates;
spraying protective paint, a topcoat, or both the protective paint and the topcoat.

11-15. (canceled)
